(19) United States
(12) Patent Application Publication
(10) Pub. No.: US 2026/0257662 A1
(43) Pub. Date: Sep. 3, 2026

(54) ENGINE SPEED CONTROL TECHNIQUES FOR IMPROVED MODE TRANSITIONS IN ELECTRIFIED POWERTRAINS WITH A DISCONNECT CLUTCH AND A LOW VEHICLE BELT-DRIVEN STARTER GENERATOR

(71) Applicant: FCA US LLC, Auburn Hills, MI (US)

(72) Inventors: Nadirsh D Patel, Auburn Hills, MI (US); Abdulquadri Oluwatobi Banuso, Auburn Hills, MI (US); Amit Kuruvilla George, Auburn Hills, MI (US); Kyle D Ringwelski, Auburn Hills, MI (US); Krishna Chaitanya Reddy Madireddy, Auburn Hills, MI (US); Handxing Sha, Auburn Hills, MI (US)

(21) Appl. No.: 19/066,260

(22) Filed: Feb. 28, 2025

(51) Int. Cl. B60W 20/15; B60W 10/02; B60W 10/06; B60W 10/08

(52) U.S. Cl. CPC B60W 20/15; B60W 10/02; B60W 10/06; B60W 10/08; B60W 20/17; B60W 2510/0638

(57) ABSTRACT

An engine speed control system and method for an electrified vehicle include a control system configured to, in response to a request for a mode transition of an electrified powertrain from an electric-only mode where a disconnect clutch is open to a hybrid mode where the disconnect clutch is closed, calculate a torque disturbance term for an engine speed model, the torque disturbance term representing torque inaccuracies of an engine system comprising an engine and a low voltage belt-driven starter-generator (BSG) and the disconnect clutch, determine, using the engine speed model and the calculated torque disturbance term, a target engine speed profile for the engine system during the mode transition, and control the engine system based on the target engine speed profile during the mode transition to prevent noise/vibration/harshness (NVH) caused by control windup and overshoot of the target engine speed profile.

### FIELD

The present application generally relates to electrified vehicles and, more particularly, to engine speed control techniques for improved mode transitions in electrified powertrains with a disconnect clutch and a low voltage belt-driven starter-generator (BSG).

### BACKGROUND

Some electrified vehicles have an electrified powertrain including an engine and a low voltage belt-driven starter-generator (BSG) separated from an electric motor by a disconnect clutch. During mode transitions where the disconnect clutch transitions from an open state (EV mode) to a closed state (hybrid mode), imperfect torque estimations from the engine and the clutch lead to inaccuracies in a feedforward engine speed model. This can cause control windup and engine speed overshoots, which causes driveline jerk or noise/vibration/harshness (NVH) that could be noticeable to a driver. This problem is unique to low voltage (e.g., 12 V) BSG embodiments as more powerful BSG embodiments could be capable of assisting the engine speed control to avoid such windup. Accordingly, while conventional control systems do work for their intended purpose, there exists an opportunity for improvement in the relevant art.

### SUMMARY

According to one example aspect of the invention, an engine speed control system for an electrified vehicle is presented. In one exemplary implementation, the engine speed control system comprises an engine system of an electrified powertrain of the electrified vehicle, the engine system comprising an engine and a low voltage belt-driven starter-generator (BSG), wherein the electrified powertrain further comprises an electric motor separated from the engine system by a disconnect clutch and a control system configured to, in response to a request for a mode transition of the electrified powertrain from an electric-only mode where the disconnect clutch is open to a hybrid mode where the disconnect clutch is closed, calculate a torque disturbance term for an engine speed model, the torque disturbance term representing torque inaccuracies of the engine system and the disconnect clutch, determine, using the engine speed model and the calculated torque disturbance term, a target engine speed profile for the engine system during the mode transition, and control the engine system based on the target engine speed profile during the mode transition to prevent noise/vibration/harshness (NVH) caused by control windup and overshoot of the target engine speed profile.

In some implementations, the control system is further configured to estimate a torque disturbance of each of the engine, the BSG, and the disconnect clutch. In some implementations, the control system is configured to calculate the disturbance torque term (T_{disturbance}) is performed as follows:

$${T}_{disturbance} = - {T}_{a , disturbance} - {T}_{eng , disturbance} + {T}_{clutch , disturbance} , \qquad ( 1 )$$

where T_{a,disturbance}, T_{eng,disturbance}, and T_{clutch,disturbance} represent the estimated disturbance torques of the BSG, the engine, and the disconnect clutch, respectively. In some implementations, the control system is further configured to use the engine speed model to calculate acceleration limits for the engine system based on the disturbance torque term.

In some implementations, the control system is further configured to calculate the acceleration limits

$$( {dN}_{i , min}^{profile} / dt and {dN}_{i , max}^{profile} / dt )$$

as follows:

$$\frac{{dN}_{i , min , max}^{profile}}{dt} = \frac{1}{( P {1}_{ratio}^{2} * {I}_{a} + {I}_{i} )} ( P {1}_{ratio} * {T}_{a}^{Min , Max} + {T}_{i}^{Pred , Min , Max} - {T}_{c}^{Min , Max} - {T}_{disturbance} - ( P {1}_{ratio}^{2} * {B}_{a} + {B}_{i} ) * {N}_{i} , \qquad ( 2 )$$

where Tᵢ_{^{Pred}} is a predicted maximum engine torque, T_{clutch} is an estimated disconnect clutch torque, P1ᵣₐₜᵢₒ represents a BSG-to-engine ratio, and B and I represent dynamic or inertia values for the engine and the BSG. In some implementations, the control system is further configured to calculate, based on the acceleration limits and the target engine speed profile, a maximum engine torque and a final engine speed profile, wherein the control system is configured to control the engine system based on the maximum engine torque and the final engine speed profile. In some implementations, the control system is further configured to perform a controlled ramp-up of the engine speed to the final engine speed profile without exceeding the final engine speed profile.

In some implementations, a first side of the electric motor is connected to an axle of the electrified vehicle via a torque converter and a gearbox and a second side of the electric motor is connected to the disconnect clutch. In some implementations, the low voltage BSG is a 12 volt powered BSG.

According to another example aspect of the invention, a method of controlling a speed of an engine system of an electrified powertrain of an electrified vehicle during mode transitions of the electrified powertrain is presented. In one exemplary implementation, the method comprises detect, by a control system of the electrified vehicle, a request for a mode transition of the electrified powertrain from an electric-only mode where a disconnect clutch is open to a hybrid mode where the disconnect clutch is closed, wherein the engine system comprises an engine and a low voltage BSG, and wherein the electrified powertrain further comprises an electric motor separated from the engine system by the disconnect clutch and, in response to detecting the request, calculating, by the control system, a torque disturbance term for an engine speed model, the torque disturbance term representing torque inaccuracies of the engine system and the disconnect clutch, determining, by the control system and using the engine speed model and the calculated torque disturbance term, a target engine speed profile for the engine system during the mode transition, and controlling, by the control system, the engine system based on the target engine speed profile during the mode transition to prevent NVH caused by control windup and overshoot of the target engine speed profile.

In some implementations, the method further comprises estimating, by the control system, a torque disturbance of each of the engine, the BSG, and the disconnect clutch. In some implementations, the calculating of the torque disturbance term (T_{disturbance}) is performed as follows:

$${T}_{disturbance} = - {T}_{a , disturbance} - {T}_{eng , disturbance} + {T}_{clutch , disturbance} , \qquad ( 1 )$$

where T_{a,disturbance}, T_{eng,disturbance}, and T_{clutch,disturbance} represent the estimated disturbance torques of the BSG, the engine, and the disconnect clutch, respectively. In some implementations, the method further comprises calculating, by the control system and using the engine speed model, acceleration limits for the engine system based on the disturbance torque term.

In some implementations, the method further comprises calculating, by the control system, the acceleration limits

$$( {dN}_{i , min}^{profile} / dt and {dN}_{i , max}^{profile} / dt ) as follows :$$

$$\frac{{dN}_{i , min , max}^{profile}}{dt} = \frac{1}{( P {1}_{ratio}^{2} * {I}_{a} + {I}_{i} )} ( P {1}_{ratio} * {T}_{a}^{Min , Max} + {T}_{i}^{Pred , Min , Max} - {T}_{c}^{Min , Max} - {T}_{disturbance} - ( P {1}_{ratio}^{2} * {B}_{a} + {B}_{i} ) * {N}_{i} ) , \qquad ( 2 )$$

where Tᵢ_{^{Pred}} is a predicted maximum engine torque, T_{clutch} is an estimated disconnect clutch torque, P1ᵣₐₜᵢₒ represents a BSG-to-engine ratio, and B and/represent dynamic or inertia values for the engine and the BSG. In some implementations, the method further comprises calculating, by the control system and based on the acceleration limits and the target engine speed profile, a maximum engine torque and a final engine speed profile, wherein the control system is configured to control the engine system based on the maximum engine torque and the final engine speed profile. In some implementations, the method further comprises performing, by the control system, a controlled ramp-up of the engine speed to the final engine speed profile without exceeding the final engine speed profile.

In some implementations, a first side of the electric motor is connected to an axle of the electrified vehicle via a torque converter and a gearbox and a second side of the electric motor is connected to the disconnect clutch. In some implementations, the low voltage BSG is a 12 volt powered BSG.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is an example plot illustrating conventional control windup and engine speed overshoot during an electric-only to hybrid mode transition of an electrified powertrain according to the principles of the prior art;

FIG. 2 is a functional block diagram of an electrified vehicle having an example electrified powertrain and an example engine speed control system according to the principles of the present application;

FIGS. 3A-3B are functional block diagrams of example system architectures for the engine speed control system according to the principles of the present application;

FIG. 4 is a flow diagram of an example torque disturbance estimation and engine speed control method for a n electrified vehicle according to the principles of the present application; and

FIG. 5 is an example plot illustrating the elimination of control windup and engine speed overshoot during an electric-only to hybrid mode transition according to the principles of the present application.

### DESCRIPTION

As previously discussed, some electrified vehicles have an electrified powertrain including an engine and a low voltage belt-driven starter-generator (BSG) separated from an electric motor by a disconnect clutch. During mode transitions where the disconnect clutch transitions from an open state (EV mode) to a closed state (hybrid mode), imperfect torque estimations from the engine and the clutch lead to inaccuracies in a feedforward engine speed model. This can cause control windup and engine speed overshoots, which causes driveline jerk or noise/vibration/harshness (NVH) that could be noticeable to a driver. This problem is unique to low voltage (e.g., 12 V) BSG embodiments as more powerful BSG embodiments could be capable of assisting the engine speed control to avoid such windup. Conventional solutions to this problem include deriving more accurate torque estimation look-up tables, which requires substantial calibration effort and time/costs, and/or blindly generating engine speed profiles without considering system limits.

Accordingly, improved torque disturbance estimation and engine speed control techniques for mode transitions (e.g., electric-only to hybrid mode transitions) of electrified powertrains are presented herein. These techniques estimate accumulated torque disturbances due to uncertainties corresponding to the engine/BSG and the clutch as described above. A new torque disturbance term is introduced in the feedforward model for defining the acceleration limits and speed profile for the engine. This results in a controlled ramp-up to the target engine speed and mitigated or eliminated control windup, which results in faster mode transitions (decrease synchronization time) and mitigated or eliminated jerk/NVH during EV-to-hybrid mode transitions. The more accurate/precise engine control could also result in decreased fuel consumption and emissions as the engine does not overshoot its target speed before eventually settling and completing the mode transition. This also does not require the substantial calibration effort to improve the torque estimation look-up tables for the engine/BSG and the disconnect clutch.

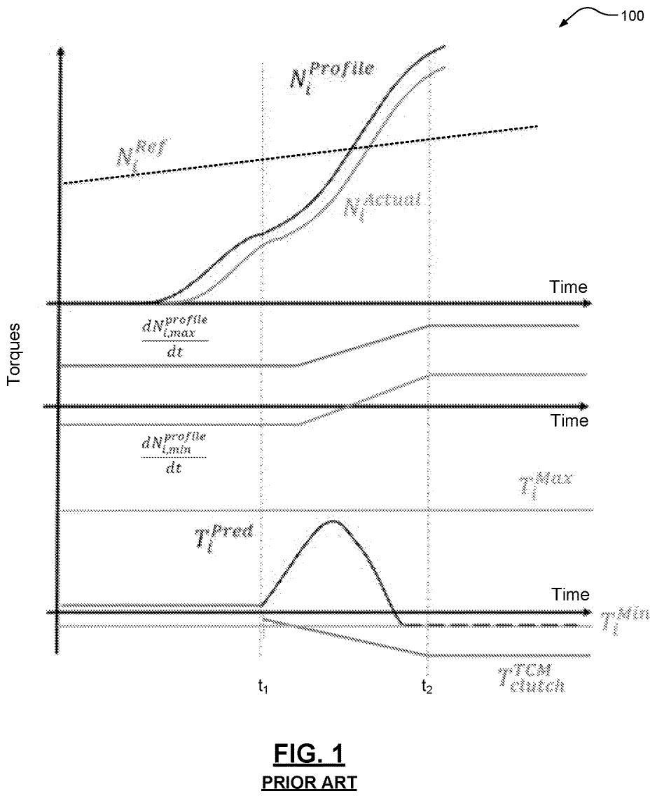

Referring now to FIG. 1, an example plot 100 illustrating conventional control windup and engine speed overshoot during an electric-only to hybrid mode transition of an electrified powertrain according to the principles of the prior art is illustrated. As shown, prior to time t₁, the engine/BSG are started and the speed (Nᵢ_{^{Actual}}) trails a target speed profile (Nᵢ_{^{Profile}}). At time t₁, the predicted engine torque (Tᵢ_{^{Pred}}) increases and the disconnect clutch torque

$$( {T}_{clutch}^{TCM} )$$

decreases. The inaccuracy of the engine torque prediction or estimation causes windup of the engine speed control, which causes the target engine speed profile Nᵢ_{^{Profile}} and the actual engine speed N Actual to overshoot a predicted static engine speed reference (Nᵢ_{^{Ref}}) before time t₂ corresponding to a completion of the mode transition of the electrified powertrain. In other words, the engine speed profile became uncontrollable and overshot the engine speed reference Nᵢ_{^{Ref}} due to overestimation of the clutch torque, which positively wound up the acceleration limits in the feedforward model, leading to excessive engine actuation. This could cause jerk or NVH that could be noticeable to a driver of the electrified vehicle.

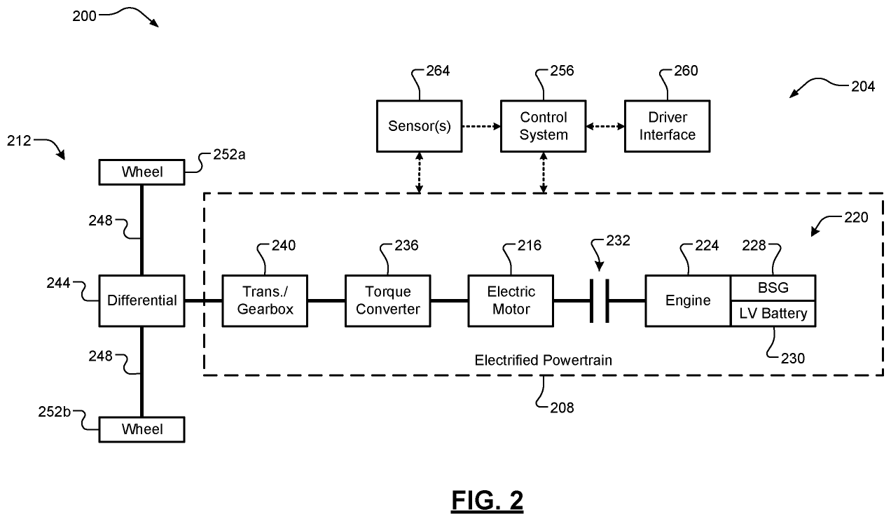

Referring now to FIG. 2, a functional block diagram of an electrified vehicle 200 having an example electrified powertrain 208 and an example engine speed control system 204 according to the principles of the present application is illustrated. The electrified powertrain 208 is configured to generate and transfer drive torque to a driveline 212 for propulsion of the electrified vehicle 200. The electrified powertrain 208 comprises two torque generating systems: an electric traction motor 216 (“electric motor 216”) and an engine system 220. The engine system 220 comprises an internal combustion engine 224 having a BSG 228 connected thereto (e.g., via a crankshaft-based pulley system, not shown). The electric motor 216 is powered by electrical energy (e.g., current) provided by a high voltage battery pack or system (not shown). The engine 220 is configured to combust a mixture of air and fuel (gasoline, diesel, etc.) to generate drive torque. The BSG 228 comprises another electric motor configured to operate as both a starter and a generator and is thus configured to be powered by a low voltage (e.g., 12 V) battery or battery system 230 to assist in starting/stopping the engine 224 and can also recharge the low voltage battery system 230 using some of the drive torque generated by the engine 224.

A disconnect clutch 232 is disposed between the engine system 220 and the electric motor 216 and is operable to control mode transitions of the electrified powertrain 208. More specifically, the electrified powertrain 208 is configured to operate in at least two different modes. In a first mode, also referred to as an electric-only or electrified vehicle (EV) mode, the disconnect clutch 232 is in an open state such that the engine system 220 is disconnected from the electric motor 216 and the electric motor 216 is configured to solely provide drive torque to the driveline 212. In a second mode, also referred to as a hybrid mode, the disconnect clutch 232 is in a closed state such that the engine system 220 is connected to the electric motor 216 and to the driveline 212. The drive torque from the electric motor 216 and, optionally, from the engine system 220, is provided to the driveline 212 via a fluid coupling or torque converter 236 and a transmission or gearbox 240. As shown, the driveline 212 is connected to the gearbox 240 and configured to distribute the drive torque to opposing left/ride sides of the electrified vehicle 200. A final drive ratio (not shown) could also be included as part of the transmission 240 or separate from the gearbox 240.

A differential 244 of the driveline 212 is configured to distributes the drive torque to opposing sides (or half-shafts) of an axle 248 (e.g., a front axle of the electrified vehicle 200) and to opposing wheels 252a, 252b. A control system 256 is configured to control operation of the electrified vehicle 200, which primarily involves controlling the electrified powertrain 208 to generate a sufficient amount of drive torque to satisfy a driver torque request. The driver torque request is provided by a driver of the electrified vehicle 200 via a driver interface 260 (e.g., an accelerator pedal). The control system 256 is also configured to receive, from one or more sensors 264, measured operating parameters of the electrified vehicle 200, including, but not limited to, positions/speeds/accelerations, temperatures, pressures, and electrical parameters (e.g., battery system state of charge, or SOC). The control system 256 is also configured to execute the torque disturbance estimation and engine speed control techniques of the present application, which will now be described in greater detail.

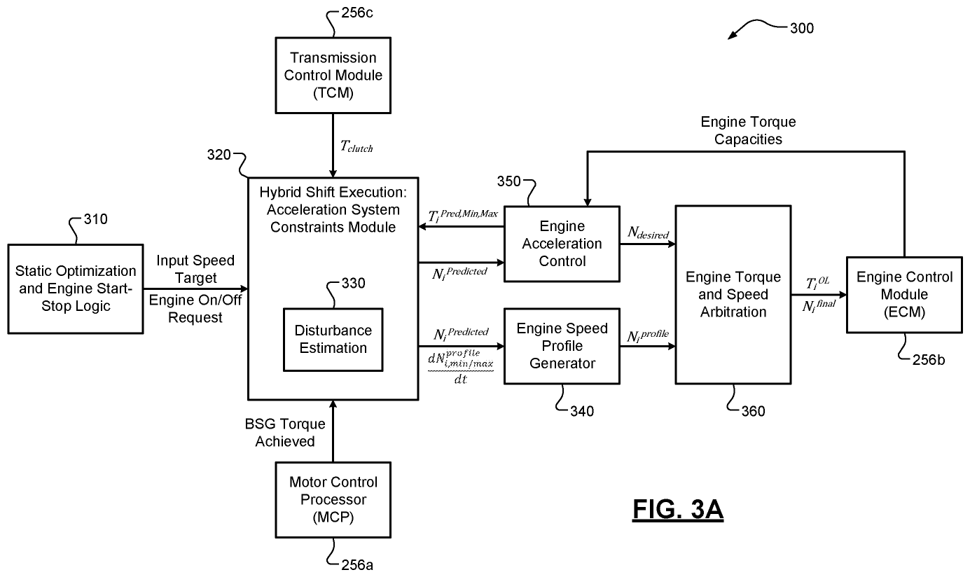

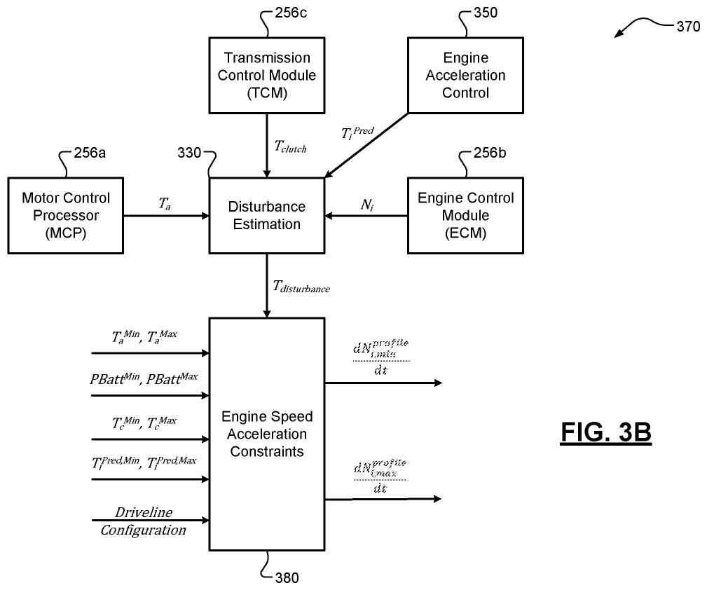

Referring now to FIGS. 3A-3B and with continued reference to FIG. 2, functional block diagram of example system architectures 300, 370 for the engine speed control system 204 according to the principles of the present application is illustrated. As shown, the control system 256 is split into various electronic control units (ECUs) that are in communication with each other via a controller area network (CAN). In the illustrated embodiment, the control system 256 includes a motor control processor (MCP) 256a, which could be part of a supervisory ECU (e.g., a hybrid control processor, or HCP), an engine control module (ECM) 256b, and a transmission control module (TCM) 256c. To begin, a static optimization and engine start-stop logic block or module 310 generates an initial speed target and an engine on/off request, which are provided to an acceleration system constraints module 320, which controls hybrid shift execution (i.e., the opening/closing of the disconnect clutch 232). The acceleration system constraints module 320 also receives a clutch torque (T_{clutch}) from the TCM 256c and an achieved torque by the BSG 228 from the MCP 256a. As shown, a disturbance estimation module 330 is included as part of the acceleration system constraints module 320.

The disturbance estimation module 330 is configured to estimate the torque disturbances in the system (i.e., the electrified powertrain 208) to address the above-described inaccuracies in the feedforward model. In one embodiment, the disturbance estimation module 330 is configured to estimate a torque disturbance term (T_{disturbance}) using a torque observer formulation based on an assumption that the engine speed is fully measurable (e.g., using sensor(s) 264) and observable. The term T_{disturbance} can be further decomposed into:

$${T}_{disturbance} = - {T}_{a , disturbance} - {T}_{eng , disturbance} + {T}_{clutch , disturbance} , \qquad ( 1 )$$

which represents the unmodelled disturbances acting on the system from the different torque input sources lumped into a single term, where T_{a,disturbance}, T_{eng,disturbance}, and T_{clutch,disuturbance} represent the disturbance torques from the BSG 228, the engine 224 and the disconnect clutch 232, respectively. It considers a dynamic model of the engine speed and torque, clutch torque, and BSG torque as defined below. The torque balance of the disturbance system then becomes:

$$P {1}_{ratio} * {T}_{a} + {T}_{i}^{pred} - {T}_{clutch} - {T}_{disturbance} - ( P {1}_{ratio}^{2} * {B}_{a} + {B}_{i} ) * {N}_{i} = ( P {1}_{ratio}^{2} * {I}_{a} + {I}_{i} ) * {\dot{N}}_{i} , \qquad ( 2 )$$

$$and {\dot{T}}_{disturbance} = 0 ,$$

where Tᵢ_{^{Pred}} is a predicted maximum engine torque, T_{clutch} is the estimated disconnect clutch torque (from the TCM 256c), T_{disturbance} is the disturbance torque, P1ᵣₐₜᵢₒ represents a BSG/engine ratio, and the values of B and I represent dynamics/inertias for the engine 224 and the BSG 228.

By using simple matrix multiplication, the disturbance plant dynamics are merged to obtain the following state-space formulation, where the state matrices are defined below:

$$\begin{matrix}{x}_{k} = {Ax}_{k - 1} + {Bu}_{k - 1} \\ {y}_{k} = {Cx}_{x}\end{matrix} , where \qquad ( 3 )$$

$$A = [ \begin{matrix}\frac{- ( {B}_{i} + {B}_{a} * P {1}_{ratio}^{2} )}{( {I}_{i} + {I}_{a} * P {1}_{ratio}^{2} )} & - \frac{1}{( {I}_{i} + {I}_{a} * P {1}_{ratio}^{2} )} \\ 0 & 0\end{matrix} ] , \qquad ( 4 )$$

$$B = [ \begin{matrix}\frac{1}{( {I}_{i} + {I}_{a} * P {1}_{ratio}^{2} )} & \frac{1}{( {I}_{i} + {I}_{a} * P {1}_{ratio}^{2} )} & - \frac{1}{( {I}_{i} + {I}_{a} * P {1}_{ratio}^{2} )} \\ 0 & 0 & 0\end{matrix} ] , and \qquad ( 5 )$$

$$C = [ \begin{matrix}1 & 0\end{matrix} ] . \qquad ( 6 )$$

The state input and output vectors are thus defined as:

$$x ( \cdot ) = [ \begin{matrix}{N}_{i} \\ {T}_{disturbance}\end{matrix} ] , and \qquad ( 7 )$$

$$x ( \cdot ) = [ \begin{matrix}{N}_{i} \\ {T}_{disturbance}\end{matrix} ] . \qquad ( 8 )$$

Using this formulation, a novel estimation solution is proposed where the estimation structure incorporates the disturbance torques from the difference sources. This is then integrated into the hybrid (e.g., system 300) to compute the limits of acceleration as shown below.

Specifically, this calculation could be performed by an engine speed acceleration constraints block or module 380 as shown in FIG. 3B.

$$\frac{{dN}_{i , min , max}^{profile}}{dt} = \frac{1}{( P {1}_{ratio}^{2} * {I}_{a} + {I}_{i} )} ( P {1}_{ratio} * {T}_{a}^{Min , Max} + {T}_{i}^{Pred , Min , Max} - {T}_{c}^{Min , Max} - {T}_{disturbance} - ( P {1}_{ratio}^{2} * {B}_{a} + {B}_{i} ) * {N}_{i} ) . \qquad ( 9 )$$

As shown, these constraints

$${dN}_{i , min}^{profile} / dt and {dN}_{i , max}^{profile} / dt$$

are output to an engine speed profile generator 340 along with the predicted engine speed Nᵢ_{^{predicted}}. The engine speed profile generator 340 then, based on these inputs, generates an engine speed profile Nᵢ_{^{profile}}, which is provided to an engine torque and speed arbitration block or module 360 for arbitration (based on the system constraints) to output a final engine torque (Tᵢ_{^{OL}}) and a final engine speed profile (Nᵢ_{^{final}}) for the ECM 256b to then control the engine system 220 accordingly. As shown in FIG. 3A, an engine acceleration control block or module 350 also receives the predicted engine speed profile Nᵢ_{^{profile}}, and returns (e.g., based on the engine torque capacities provided by the ECM 256b) predicted minimum and maximum engine torques Tᵢ_{^{Pred,Min}} and Tᵢ_{^{Pred,Max}} to the disturbance estimation module 330 for use in its calculations (see, e.g., FIG. 3B). The final control by the ECM 256b using the final engine torque Tᵢ_{^{OL and the final engine speed profile N}}ᵢ_{^{final}} results in the engine speed having a controlled ramp-up to the target speed without any windup and overshoot that would cause the NVH as discussed herein.

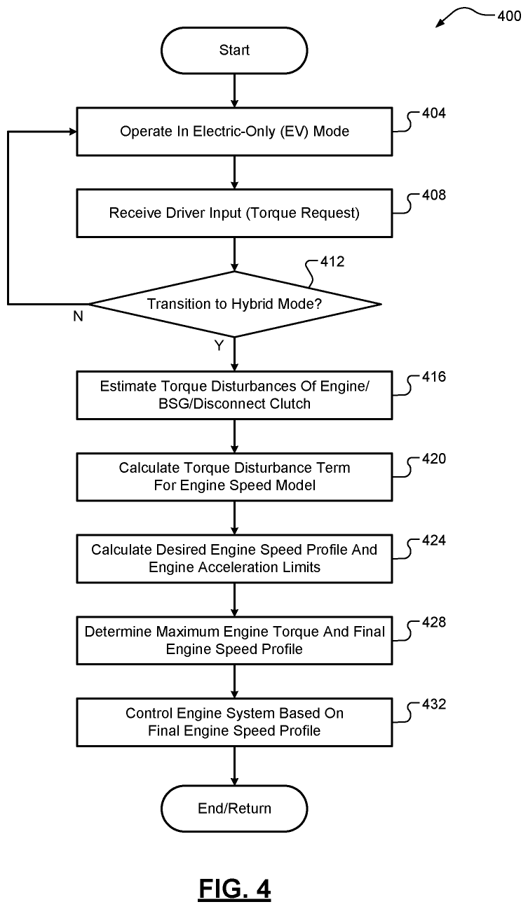

Referring now to FIG. 4 and with continued reference to FIGS. 2-3B, a flow diagram of an example torque disturbance estimation and engine speed control method 400 for an electrified vehicle according to the principles of the present application is illustrated. While the electrified vehicle 200 and its components are referenced for descriptive/illustrative purposes, it will be appreciated that the method 400 could be applicable to any suitably configured electrified vehicle (e.g., with an electric motor and an engine with a low voltage BSG). The method 400 begins at 404 where the control system 256 operates the electrified powertrain 208 in the electric-only or EV mode where the disconnect clutch 232 is open. At 408, the control system 256 receives a driver torque request from the driver interface 260. At 412, the control system 256 determines whether a mode transition from the electric-only or EV mode to the hybrid mode is necessary based on the driver input. When false, the method 400 returns to 404. When true, the method 400 proceeds to 416. At 416, the control system 256 estimates torque disturbances of the engine 224, the BSG 228, and the disconnect clutch 232. At 420, the control system 256 calculates the torque disturbance term for the engine speed model based on the estimated torque disturbances. At 424, the control system 256 calculates a desired engine speed profile and engine acceleration limits using the engine speed model and the torque disturbance term.

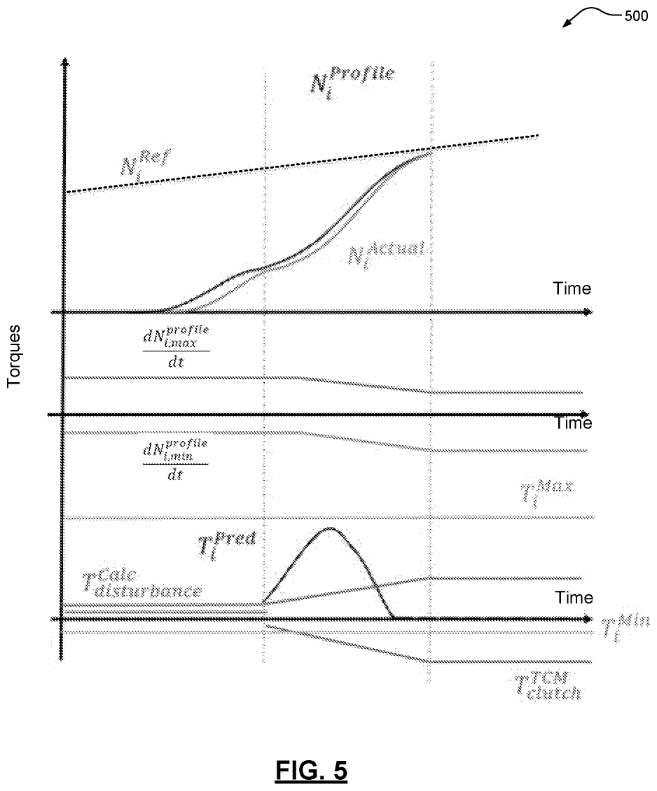

At 428, the control system 256 determines a maximum engine torque and final engine speed profile based on the desired speed profile and the acceleration limits. Finally, at 432, the control system 256 controls the engine system 220 according to the maximum engine torque and the final engine speed profile to perform a controlled ramp-up to the target engine speed without any windup or overshoot that would cause the NVH previously described herein. FIG. 5, for example, depicts an example plot 500 illustrating the elimination of control windup and engine speed overshoot during an electric-only to hybrid mode transition according to the principles of the present application. In the illustrated example, a request is made to start the engine 224 and synchronize it with the driveline 212. A predicted static engine speed is set, Nᵢ_{^{ref}}, and the clutch 232 is actuated. The system 200 controls the speed profile and acceleration limits by counterbalancing disturbance torque, leading to a controlled ramp-up to the target engine speed and reducing windup. Refining the feedforward constraints model with the disturbance term minimizes vibrations during synchronization, ensuring smoother transitions from EV to hybrid mode and reducing synchronization time.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An engine speed control system for an electrified vehicle, the engine speed control system comprising:
an engine system of an electrified powertrain of the electrified vehicle, the engine system comprising an engine and a low voltage belt-driven starter-generator (BSG), wherein the electrified powertrain further comprises an electric motor separated from the engine system by a disconnect clutch; and
a control system configured to, in response to a request for a mode transition of the electrified powertrain from an electric-only mode where the disconnect clutch is open to a hybrid mode where the disconnect clutch is closed:
calculate a torque disturbance term for an engine speed model, the torque disturbance term representing torque inaccuracies of the engine system and the disconnect clutch;
determine, using the engine speed model and the calculated torque disturbance term, a target engine speed profile for the engine system during the mode transition; and
control the engine system based on the target engine speed profile during the mode transition to prevent noise/vibration/harshness (NVH) caused by control windup and overshoot of the target engine speed profile.

2. The engine speed control system of claim 1, wherein the control system is further configured to estimate a torque disturbance of each of the engine, the BSG, and the disconnect clutch.

3. The engine speed control system of claim 2, wherein the control system is configured to calculate the disturbance torque term (T_{disturbance}) is performed as follows:
$${T}_{disturbance} = - {T}_{a , disturbance} - {T}_{eng , disturbance} + {T}_{clutch , disturbance} , \qquad ( 1 )$$
where T_{a,disturbance}, T_{eng,disturbance}, and T_{clutch,disturbance} represent the estimated disturbance torques of the BSG, the engine, and the disconnect clutch, respectively.

4. The engine speed control system of claim 3, wherein the control system is further configured to use the engine speed model to calculate acceleration limits for the engine system based on the disturbance torque term.

5. The engine speed control system of claim 4, wherein the control system is further configured to calculate the acceleration limits
$$( {dN}_{i , min}^{profile} / dt and {dN}_{i , max}^{profile} / dt ) as follows :$$
$$\frac{{dN}_{i , min , max}^{profile}}{dt} = \frac{1}{( P {1}_{ratio}^{2} * {I}_{a} + {I}_{i} )} ( P {1}_{ratio} * {T}_{a}^{Min , Max} + {T}_{i}^{Pred , Min , Max} - {T}_{c}^{Min , Max} - {T}_{disturbance} - ( P {1}_{ratio}^{2} * {B}_{a} + {B}_{i} ) * {N}_{i} ) , \qquad ( 2 )$$
where Tᵢ_{^{Pred}} is a predicted maximum engine torque, T_{clutch} is an estimated disconnect clutch torque, P1ᵣₐₜᵢₒ represents a BSG-to-engine ratio, and B and I represent dynamic or inertia values for the engine and the BSG.

6. The engine speed control system of claim 5, wherein the control system is further configured to calculate, based on the acceleration limits and the target engine speed profile, a maximum engine torque and a final engine speed profile, wherein the control system is configured to control the engine system based on the maximum engine torque and the final engine speed profile.

7. The engine speed control system of claim 6, wherein the control system is further configured to perform a controlled ramp-up of the engine speed to the final engine speed profile without exceeding the final engine speed profile.

8. The engine speed control system of claim 1, wherein a first side of the electric motor is connected to an axle of the electrified vehicle via a torque converter and a gearbox and a second side of the electric motor is connected to the disconnect clutch.

9. The engine speed control system of claim 1, wherein the low voltage BSG is a 12 volt powered BSG.

10. A method of controlling a speed of an engine system of an electrified powertrain of an electrified vehicle during mode transitions of the electrified powertrain, the method comprising:
detecting, by a control system of the electrified vehicle, a request for a mode transition of the electrified powertrain from an electric-only mode where a disconnect clutch is open to a hybrid mode where the disconnect clutch is closed, wherein the engine system comprises an engine and a low voltage belt-driven starter-generator (BSG), and wherein the electrified powertrain further comprises an electric motor separated from the engine system by the disconnect clutch; and
in response to detecting the request:
calculating, by the control system, a torque disturbance term for an engine speed model, the torque disturbance term representing torque inaccuracies of the engine system and the disconnect clutch;
determining, by the control system and using the engine speed model and the calculated torque disturbance term, a target engine speed profile for the engine system during the mode transition; and
controlling, by the control system, the engine system based on the target engine speed profile during the mode transition to prevent noise/vibration/harshness (NVH) caused by control windup and overshoot of the target engine speed profile.

11. The method of claim 10, further comprising estimating, by the control system, a torque disturbance of each of the engine, the BSG, and the disconnect clutch.

12. The method of claim 11, wherein the calculating of the torque disturbance term (T_{disturbance}) is performed as follows:
$${T}_{disturbance} = - {T}_{a , disturbance} - {T}_{eng , disturbance} + {T}_{clutch , disturbance} , \qquad ( 1 )$$
where T_{a,disturbance}, T_{eng,disturbance}, and T_{clutch,disturbance} represent the estimated disturbance torques of the BSG, the engine, and the disconnect clutch, respectively.

13. The method of claim 12, further comprising calculating, by the control system and using the engine speed model, acceleration limits for the engine system based on the disturbance torque term.

14. The method of claim 13, further comprising calculating, by the control system, the acceleration limits
$$( {dN}_{i , min}^{profile} / dt and {dN}_{i , max}^{profile} / dt ) as follows :$$
$$\frac{{dN}_{i , min , max}^{profile}}{dt} = \frac{1}{( P {1}_{ratio}^{2} * {I}_{a} + {I}_{i} )} ( P {1}_{ratio} * {T}_{a}^{Min , Max} + {T}_{i}^{Pred , Min , Max} - {T}_{c}^{Min , Max} - {T}_{disturbance} - ( P {1}_{ratio}^{2} * {B}_{a} + {B}_{i} ) * {N}_{i} ) , \qquad ( 2 )$$
where Tᵢ_{^{Pred}} is a predicted maximum engine torque, T_{clutch} is an estimated disconnect clutch torque, P1ᵣₐₜᵢₒ represents a BSG-to-engine ratio, and B and I represent dynamic or inertia values for the engine and the BSG.

15. The method of claim 14, further comprising calculating, by the control system and based on the acceleration limits and the target engine speed profile, a maximum engine torque and a final engine speed profile, wherein the control system is configured to control the engine system based on the maximum engine torque and the final engine speed profile.

16. The method of claim 15, further comprising performing, by the control system, a controlled ramp-up of the engine speed to the final engine speed profile without exceeding the final engine speed profile.

17. The method of claim 10, wherein a first side of the electric motor is connected to an axle of the electrified vehicle via a torque converter and a gearbox and a second side of the electric motor is connected to the disconnect clutch.

18. The method of claim 10, wherein the low voltage BSG is a 12 volt powered BSG.
